(19) United States
(12) Patent Application Publication
(10) Pub. No.: US 2009/0220780 A1
(43) Pub. Date: Sep. 3, 2009

(54) TUBULAR THREADED ELEMENT PROVIDED WITH A DRY PROTECTIVE COATING

(75) Inventors: Laurent Bordet, Lille (FR); Laurent Gillot, Valenciennes (FR); Eliette Pinel, Lyon (FR); Eric Gard, Sathonay Village (FR)

Correspondence Address: OBLON, SPIVAK, MCCLELLAND MAIER & NEUSTADT, P.C., 1940 DUKE STREET, ALEXANDRIA, VA, 22314, US

(73) Assignees: Vallourec Mannesmann Oil & Gas France, Aulnoye Aymeries (FR); Sumitomo Metal Industries, Ltd., Osaka-shi (JP)

(21) Appl. No.: 12/089,467

(22) PCT Filed: Oct. 4, 2006
(86) PCT No.: PCT/EP06/09707

§ 371 Date: Aug. 21, 2008

(30) Foreign Application Priority Data
Oct. 14, 2005 (FR) 0510503

(51) Int. Cl. B32B 9/00; C10M 139/06; C10M 155/02; C10M 131/02; C10M 125/02; B05D 3/00; B05D 1/08; B05D 3/02

(52) U.S. Cl. 428/336; 508/100; 508/108; 508/101; 508/107; 508/106; 508/109; 428/335; 427/299; 427/446; 427/314; 977/734

(57) ABSTRACT

A tubular threaded element including a dry protective coating. The coating includes a solid matrix adhering to the substrate in which are dispersed particles of solid lubricants from at least two classes that are selected to exert a synergistic effect between themselves and with the constituents of the matrix, i.e. coating provides protection against corrosion and against galling of the threadings of threaded elements used in hydrocarbon wells.

The invention relates to a threaded element for a threaded tubular connection.

### PRIOR ART

Threaded elements produced at the end of a tubular component (tube or coupling) used in hydrocarbon wells must first be protected against corrosion during transport and storage at the drilling site and to this end, they are traditionally coated with protective grease or oil on leaving the production shop.

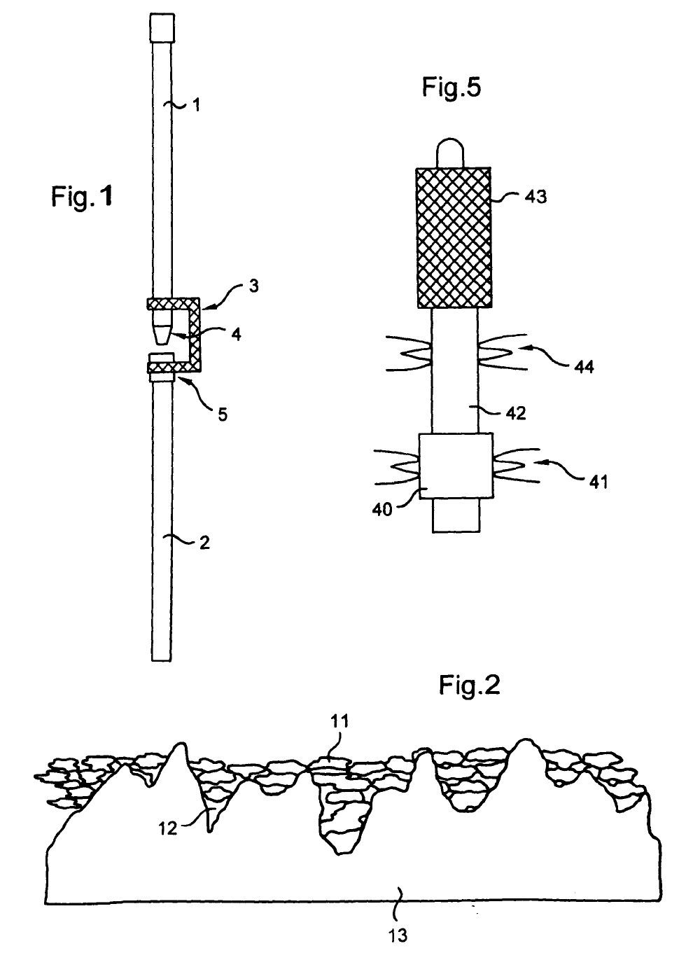

At the well, they may have to undergo several makeup-breakout cycles. Makeup operations are carried out vertically under high axial load, for example the weight of a tube several metres in length (typically 10 to 13 metres in length) to be assembled vertically via the threaded connection, which runs the risk of galling, in particular at the threading. Moreover said load may also be localized due to a slight misalignment in the axes of the threaded elements to be assembled because the tube to be assembled is suspended vertically, which increases the risk of galling. Thus, FIG. 1 shows on site assembling via a threaded connection of two tubes 1 and 2, which are 10 to 13 metres in length, with a misalignment, power tongs 3 being used to make up the male threaded portion 4 of tube 1 into the female threaded portion 5 of tube 2.

To protect the sensitive parts such as threadings against galling during makeup-breakout operations, the threadings are traditionally freed of protective grease and coated with special makeup grease such as grease meeting the specifications of API Bul 5A2 or 5A3. In addition to the disadvantage of having to provide a second coating on site, the use of such grease, charged with heavy and/or toxic metals such as lead, also causes pollution of the well and the environment, as the excess grease is ejected from the threadings during makeup.

U.S. Pat. No. 6,933,264 proposes replacing the double coating by a single coating, carried out in the shop for producing the threaded elements, using a thin layer of a lubricant with a waxy consistency (known as semi-dry) comprising at least one extreme pressure additive having a chemical action. Said semi-dry coating, however, suffers from the drawback of requiring mechanical protection against pollution by dust or sand particles during transport and storage.

U.S. Pat. No. 4,414,247, U.S. Pat. No. 4,630,849, U.S. Pat. No. 6,027,145, U.S. Pat. No. 6,679,526, US-2004/0166341 A1 and International patent application WO-2004/033951 propose replacing the grease by a variety of protective solid coatings applied in the shop for producing the threaded elements, comprising a solid matrix which adheres to the substrate and in which solid lubricating particles are dispersed; molybdenum disulphide, MoS₂, is among the most particularly cited compounds.

Such coatings, while representing an improvement over grease, are still not entirely satisfactory. In particular, under drill site conditions, the coating frequently flakes off and/or particles are torn from the rubbed surface thereof and dispersed into the environment, such incidents involving returning the tubular component to the plant.

In addition, such coatings generally require hardening by heating in a furnace to about 200° C. for several tens of minutes or even for over an hour, which considerably adds to the complexity of the coating production cycle, which cannot be linked to machining the threadings.

Further, they generally do not or do not sufficiently protect the threaded elements from corrosion, and so U.S. Pat. No. 6,679,526 and WO-2004/033951 propose applying a separate layer of a corrosion inhibiting material (a metal salt of a carboxylic acid in the first document, an epoxy resin containing zinc particles in the second document).

Such a two-layered coating necessitates even more complex production cycles and still does not overcome particle tear off problems.

The aim of the invention is to overcome the disadvantages of known greases and dry or semi-dry coatings, at least from the tribological viewpoint under on-site conditions and as regards the productivity of application of the coating, and optionally from the corrosion viewpoint.

The term “makeup under on-site conditions” means makeup in the vertical position in which (i) a first threaded element is fixed in a vertical position and (ii) a second threaded element to be made up into the first threaded element, disposed at or integral with the lower end of a tube which may be 13 metres long, is kept substantially vertically above the first threaded element by a lifting device, the second threaded element then being made up into the first using a suitable device such as power tongs. Similarly, the term “breakout under on-site conditions” means breakout of vertically disposed first and second threaded elements and thus supporting the weight of a tube and possibly subject to misalignment, the tube to be broken out being suspended from a lifting device.

In particular, the invention provides a threaded element for a threaded tubular connection which is resistant to galling, comprising a threading coated with a solid thin coating which is not sticky to the touch and adheres to the substrate, which comprises a solid matrix in which particles of solid lubricant are suspended.

According to the invention, the solid matrix is lubricating and exhibits plastic or viscoplastic type rheological behaviour, and said particles of solid lubricant comprise particles of lubricants from at least two of classes 1, 2, 3 and 4, as will be defined below.

Optional characteristics of the invention, which may be complementary or substitutional, are set out below:
said matrix has a melting point in the range 80° C. to 320° C.;
said matrix comprises at least one thermoplastic polymer;
said thermoplastic polymer is polyethylene;
said matrix comprises at least one metal soap;
the soap is fitted for contributing to capture coating debris produced by friction;
the soap is zinc stearate;
said matrix comprises at least one wax of vegetable, animal, mineral or synthetic origin;
the wax is fitted for contributing to capture debris from the coating produced by friction;
the wax is carnauba wax;
said matrix comprises at least one corrosion inhibitor; the corrosion inhibitor is a calcium sulphonate derivative;
the soap is selected to improve the time to appearance of corrosion under the ISO 9227 standard salt spray corrosion test;
said matrix comprises at least one liquid polymer with a kinematic viscosity at 100° C. of at least 850 mm²/s;
said liquid polymer is insoluble in water;
said liquid polymer is selected from an alkyl polymethacrylate, a polybutene, a polyisobutene and a polydialkylsiloxane;
said matrix comprises at least one surface-active agent;
said matrix comprises at least one colorant;
said matrix comprises at least one antioxidant;
the solid lubricant particles comprise particles of at least one solid lubricant from class 2 and at least one solid lubricant from class 4;
the solid lubricant particles comprise particles of at least one solid lubricant from class 1, at least one solid lubricant from class 2 and at least one solid lubricant from class 4;
the solid lubricant particles do not comprise graphite particles;
the solid lubricant particles comprise at least boron nitride particles as the solid lubricant from class 1;
a the solid lubricant particles do not comprise molybdenum disulphide particles;
the solid lubricant particles comprise particles of at least one solid lubricant from class 2 selected from graphite fluoride, sulphides of tin and sulphides of bismuth;
the solid lubricant particles comprise at least polytetrafluoroethylene particles as the solid lubricant from class 4;
said coating comprises molecules of at least one fullerene with a spherical geometry;
the composition by weight of the matrix is as follows:

| | |
|---|---|
| polyethylene homopolymer | 15% to 90% |
| carnauba wax | 5% to 30% |
| zinc stearate | 5% to 30% |
| calcium sulphonate derivative | 0 to 50% |
| alkyl polymethacrylate | 0 to 15% |
| colorant | 0 to 1% |
| antioxidant | 0 to 1% |

the composition by weight of the matrix is as follows:

| | |
|---|---|
| polyethylene homopolymer | 15% to 90% |
| carnauba wax | 5% to 30% |
| zinc stearate | 5% to 30% |
| calcium sulphonate derivative | 0 to 50% |
| alkyl polymethacrylate | 0 to 15% |
| polydimethylsiloxane | 0 to 2% |
| colorant | 0 to 1% |
| antioxidant | 0 to 1% |

the composition by weight of the solid lubricants is as follows:

| | |
|---|---|
| graphite fluoride | 20% to 99% |
| boron nitride | 0% to 30% |
| polytetrafluoroethylene | 1% to 80% |

the composition by weight of the solid lubricants is as follows:

| | |
|---|---|
| sulphides of tin | 20% to 99% |
| boron nitride | 0 to 30% |
| polytetrafluoroethylene | 1% to 80% |

the composition by weight of the solid lubricants is as follows:

| | |
|---|---|
| sulphides of bismuth | 20% to 99% |
| boron nitride | 0 to 30% |
| polytetrafluoroethylene | 1% to 80% |

the composition by weight of the coating is as follows:

| | |
|---|---|
| matrix | 70% to 95% |
| solid lubricants | 5% to 30% |

the thickness of the coating is in the range 10 μm to 50 μm;
the coating is also applied to a sealing surface which is fitted to come into sealed interference contact with a corresponding surface of a second threaded element after connection of the two threaded elements by makeup;

The invention also pertains to a threaded tubular connection comprising a male threaded element and a female threaded element in which at least one of said threaded elements is as defined above, and to a method for finishing a threaded tubular element, in which a thin layer of a solid anti-galling coating as defined above is applied to at least the surface of the threading after having subjected the surface to be coated to a surface treatment which is fitted to improve adhesion of the coating.

The method of the invention may comprise at least some of the following features:
heating the constituents of the coating to a temperature which is higher than the melting point of the matrix and the coating is then applied by spraying said constituents comprising the molten matrix;
the coating is applied by projection through a flame of a powder formed by the constituents of the coating;
the coating is applied by spraying an aqueous emulsion in which the constituents of the coating are dispersed;
the threaded element is heated to a temperature of 80° C. or more;
the threaded element is held at ambient temperature;
said surface treatment is selected from mechanical treatments, chemical treatments and non reactive deposits;
the surface to be coated is a metallic surface and said surface treatment is a treatment for chemical conversion of said surface;
said chemical conversion treatment is a phosphatation;
said surface treatment is followed by a treatment for impregnating the roughness or pores of the surface to be coated (12) by nanomaterials (11) with an anticorrosive action;
said nanomaterials are particles (11) of zinc oxide;
said nanomaterials have a mean particle size of the order of 200 nm;
said nanomaterials are applied in the form of an aqueous dispersion.

The characteristics and advantages of the invention will become apparent from the description below, made with reference to the accompanying drawings.

FIG. 1 shows a diagram of two tubes which are ready to be assembled by makeup of their threaded elements in a hydrocarbon well.

FIG. 2 shows, on a larger scale, a portion of the threaded surface of a threaded element the pores of which are impregnated by nanomaterials in accordance with the method of the invention.

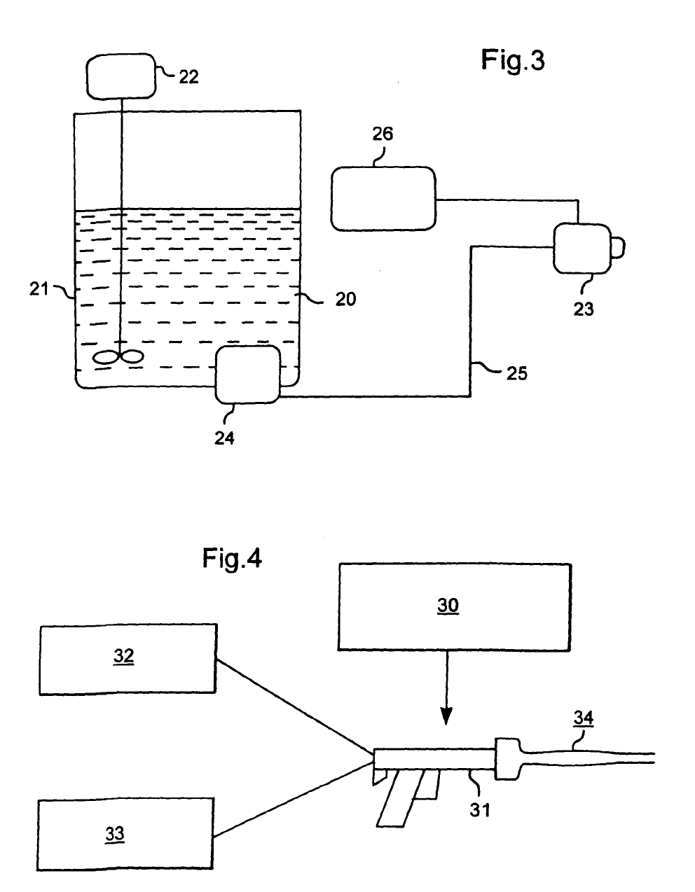

FIGS. 3 and 4 diagrammatically show devices which can be used to carry out the method of the invention.

FIG. 5 diagrammatically shows a device for evaluating the coating of the invention by a makeup-breakout test.

The invention resides in a study of the tribological behaviour of certain materials and draws on certain notions which are summarized below.

### Fundamental Concepts

### Solid Lubricant Transfer Film Effect or Leafing Effect

Solid lubricants in the hydrodynamic and dry lubrication regime, when dispersed in a fluid or viscoplastic material, tend to become fixed on the surfaces in a stable manner, modifying the frictional characteristics thereof. They are transferred and bonded to the surface by chemical bonding, which results in good wear resistance and an improvement in frictional properties. The nature of the solids endows the surfaces with an anti-wear protection, with resistance and anti-wear properties at the extreme pressures generated by high surface stresses, termed Hertz pressure, and a small coefficient of friction over a wide range of loads and frictional speeds. Said properties for generating a transfer film effect or a leafing effect are used for types of friction in which the surfaces are stressed in a repetitive manner, such as that produced during makeup and breakout of systems of threaded tubular connections.

### Third Body Due to Friction

Third body due to friction occurs between two surfaces in contact during friction.

In the absence of lubricant, two bodies rubbing against one another and under stress produce a third body formed by debris, which may or may not be chemically transformed, from each of the bodies. This third body defines a part of the frictional properties by its behaviour under applied stress, its transformation mechanism under stress, and its ability to migrate, fix or be eliminated.

When a liquid, fluid or plastic solid lubricant, i.e. deforming under shear in a plastic manner with flow of material, is interposed between the two bodies, the lubricant forms a film separating the surfaces of the two bodies and itself constitutes a third body. Its composition is modified in boundary conditions, i.e. when the frictional stresses result in contact of the lubricated materials, with the production of solids mixing with the fluid or plastic material.

### Extreme Pressure Properties

These are the properties of certain products allowing surfaces suffering very high Hertz pressure to resist wear and to slide with low coefficients of friction.

### Hertz Pressure

Surfaces in contact under load deform elastically, defining a zone of contact with a certain surface area. The applied load divided by said surface area defines the Hertz pressure. During high Hertz pressure, solid non plastic materials may undergo internal shear, reducing their service life by fatigue of the material, while solid plastic materials suffer this shear without structural degradation.

### Matrix

This designates a system allowing to fix or carry an active principle to a given location. It also acts as an agent for cohesion of a heterogeneous system and may have functions which supplement those of the active principles which it binds or carries.

### Synergistic Effect

Bodies having basic properties may be combined into a complex body with completely different characteristics and behaviour. In the case when such behaviours result in performances, which are better than the cumulative performances of the constituents, a synergistic effect exists.

### Viscosity, Plasticity, Viscoplasticity, Granular Behaviour

Highly deformable or fluid bodies exist which undergo limited deformation under the effect of a hydrostatic pressure and a non-defined flow under the effect of even a small shear stress. Examples are oils and greases.

Slightly deformable or solid bodies exist which undergo limited deformation regardless of the nature of the stress, at least up to a certain stress threshold. This is the case with thermosetting systems having a yield strength beyond which the structure of the material degrades.

Most existing materials are between these two extremes (materials with elastic, plastic, viscous or viscoplastic behaviour).

The third body generated or present during friction owes its lubricating or non-lubricating properties to its physical state, as seen in Table 1 below.

TABLE 1

| Category | 1 | 2 | 3 |
|---|---|---|---|
| Physical state | Plastic solid | Granular solid | Fluid |
| of third body | | | |
| Description | Viscoplastic | Frictional-collisional | Frictional-viscous |
| of behaviour | flow | state | behaviour |
| Effect | Lubricant | Non lubricant | lubricant |

The materials used in the matrix of the invention belong to category 1 in Table 1

### Thermoplastic and Thermosetting Polymers

The term “thermoplastic” defines a polymer which is fusible, capable of being reversibly softened then melted by heating to respective temperatures T_{g} and Tₘ (glass transition temperature and melting point) and solidified by cooling. Thermoplastic polymers are transformed without chemical reaction, in contrast to thermosetting polymers. Thermoplastic polymers are used in the invention to obtain, under friction, viscous flow while in the static position retaining a dry solid structure (non adhesive) which is dry to the touch and stable. In contrast, in general, thermosetting polymers do not have or have poor viscous behaviour under stress.

### Metal Soap

This term encompasses soaps of alkali metals and alkaline-earth metals and of other metals. They are fusible compounds having the ability to flow between surfaces (category 1 in Table 1).

### Wax

This term encompasses fusible substances with lubricating properties of a variety of origins (mineral, in particular from petrol distillation, vegetable, animal or synthetic) with a more or less pasty or hard consistency and with a melting point and drop point which may vary widely depending on their nature.

### Corrosion Inhibitors

These are additives endowing a liquid or solid material applied to a surface with the ability to protect said surface from different modes of corrosion. Such corrosion inhibitors function according to various chemical, electrochemical or physicochemical mechanisms.

### Solid Lubricants

A solid lubricant is a solid stable body which, interposing between two frictional surfaces, enables to reduce the coefficient of friction and to reduce wear and damage to the surfaces. Said bodies may be classified into different categories defined by the mechanism of operation and structure:

Class 1: solid bodies owing their lubricating properties to their crystalline structure, for example graphite or boron nitride BN;

Class 2: solid bodies owing their lubricating properties to their crystalline structure and to a reactive chemical element in their composition, for example molybdenum disulphide MoS₂, graphite fluoride, sulphides of tin or sulphides of bismuth;

Class 3: solid bodies owing their lubricating properties to their chemical reactivity, for example certain thiosulphate type chemical compounds;

Class 4: solid bodies owing their lubricating properties to plastic or viscoplastic behaviour under friction stresses, for example polytetrafluoroethylene, PTFE, or polyamides.

In order to define a very high performance product, the inventors studied the synergistic properties of the various classes of solid lubricants.

Preferred solid lubricants for use in the invention comprise compounds of class 2 which until now have not been used to a great extent, such as graphite fluorides or complex tin or bismuth sulphides. According to the inventors, they differ from traditional solid lubricants such as graphite, molybdenum disulphide or tungsten disulphide in their greater ability to bind with metals and their much better performance under extreme pressure. When used synergistically with solid lubricants of other classes, they enable to achieve particularly remarkable performances.

The inventors investigated solutions which do not use graphite, which can facilitate corrosion, nor molybdenum disulphide, as this compound is known to be unstable, in particular in the presence of moisture, and to liberate corrosive oxide of sulphur for steel or hydrogen sulphide, possibly rendering the steel sensitive to hydrogen sulphide stress cracking, SSC.

### Fullerenes

These are molecular materials having a structure in the form of closed or open tubes or closed or open spheres, in a single layer or multilayers. Spherical fullerenes are several tens of nm in size in a monolayer and over about 80 nm as a multilayer. They act on the surfaces, blocking, in a stable manner, the sites created by the surface roughness and blocking flake type degradation.

### Types of Stress

The invention takes into account the various stresses to which the threaded tubular connections are subjected as they function.

### Friction at Low and High Speed, and Low and High Hertz Pressure

The frictional system during makeup and breakout of threaded connections is complicated by the wide variety of frictional speeds encountered. The speeds may be relatively high during makeup and almost zero at the end of makeup or the beginning of breakout. Further, Hertz pressure is very high during the same frictional periods, leading to limiting conditions. Thus, the inventors sought to define a system satisfying said stresses.

To overcome problems due to kinetic stresses, the inventors developed a matrix the properties of which are plastic resulting in viscous flow under stress and satisfying all of the speed situations encountered. The use of several constituents is necessary for the highest performance systems to adapt them to this wide variety of shear. Said matrix enables to maintain the other active elements in place and contribute to the production of stable transfer films or leaves.

Thermoplastic resins generally with plastic characteristics were selected and the inventors picked out polyethylene from the array of existing viscoplastic polymers, in preference to other viscoplastic polymers such as polyamide 6, polyamide 11 or polypropylene, which pose application problems due to their high viscosity in the molten state. Polyethylene types with melting points above 105° C. were selected.

Improved matrix plasticity was achieved by adding metal soap type chemical compounds, among which calcium, bismuth and zinc soaps which produced excellent results as regards the number of makeup-breakout steps under the on-site conditions described above, as well as an improvement in debris re-agglomeration properties. Zinc stearate was selected from said soaps because of its synergistic effect with the corrosion inhibitors studied below.

Incorporating natural fats such as carnauba wax into the matrix enables to optimize the debris re-agglomeration properties during makeup-breakout operations.

In order to satisfy limiting lubrication stresses under quasi-static conditions along with very high frictional loads, the inventors developed a system of suitable additives based on solid lubricants. Conventional additives only function when the surface stresses allow them to react, which only occurs under certain loads and frictional speeds. The inventors thus used the solid lubricant technique, capable of guaranteeing a lubricating regime even under quasi static conditions. The inventors more particularly used the synergistic effect between different classes of solid lubricants and the synergistic effect between them and the viscoplastic behaviour of the matrix, in order to cover all speed conditions and stress conditions encountered. These synergistic effects readily produce a leafing effect reinforced by the action of the matrix. Class 1/class 2 synergies and class 1/class 2/class 4 synergies were successfully tested.

An increase of 50% in the number of makeup-breakout cycles under on site conditions was observed with systems combining classes 1, 2 and 4, compared with a class 2/class 4 type synergy.

The inventors observed particularly good synergistic performances with the following products: graphite fluoride (class 2)/PTFE (class 4)/boron nitride (class 1), tin disulphide (class 2)/PTFE (class 4)/boron nitride (class 1) and bismuth sulphide (class 2)/PTFE (class 4)/boron nitride (class 1).

### Hostile Environment (Saline or Non Saline Humidity)

Depending on the surface anti-corrosion protection requirements, it may be necessary to incorporate corrosion inhibitors into the matrix. Of these, calcium sulphonate derivatives and in particular those derived from associating calcium oxide and calcium sulphonates in a medium constituted by waxes, petroleum resins or paraffins, such as the product sold by LUBRIZOL under the trade name ALOX 2211 Y, proved to be particularly high performance, but other compounds may also be used such as amine, aminoborate, quaternary amine, superalkalinized sulphonate on polyalphaolefin, strontium phosphosilicate, zinc phosphosilicate or borate carboxylate type may also be used.

Corrosion resistance may also be improved by associating the selected corrosion inhibitor with compounds which act by other mechanisms to block corrosion. As indicated above, zinc stearate in particular demonstrated synergistic properties with corrosion inhibitors while contributing greatly to the lubricating behaviour of the matrix.

The principal test of anticorrosion protection is the salt spray test carried out in accordance with International standard ISO 9227 and given the index Re in accordance with ISO EN 2846-3 on a plate treated by manganese phosphatation (deposit of 8 to 20 g/m² of phosphate).

### Use in a Protected Environment (Environmental Compatibility Constraints)

The matrix composition may be intended to block debris from friction on the surface to eliminate environmental pollution possibilities. Because of a suitable composition of the matrix, such debris re-agglomerates as soon as it is formed.

In order to demonstrate this property, the inventors included quantitative procedures in the experimental protocols by weighing the debris generated during friction. They were thus able to establish the efficacy of metal soaps and waxes.

However, depending on the amounts of corrosion inhibitors required, degradation of the debris trapping properties or debris re-agglomeration properties could be observed, which the inventors sought to correct. Thus, they considered the influence of very viscous polymers such as alkyl polymethacrylates (PAMA), polybutenes, polyisobutenes and polysiloxanes, excellent results in a debris re-agglomeration test being obtained with a PAMA with a kinematic viscosity of 850 mm²/s at 100° C. sold by ROHMAX under the trade name VISCOFLEX 6-950.

After some makeup-breakout cycles, an examination of two threadings provided with a coating of the invention only one of which contained a PAMA showed that with this coating, the debris produced by friction was agglomerated and incorporated onto the frictional surface without causing external pollution, while with another coating the debris remained dispersed.

Coating Applicability

To improve the adhesion of the coating at ambient temperature, it may be necessary to add at least one surface-active agent (also called surfactant) to the matrix.

In this regard the inventors have more specially considered the addition of 2% or less of polydimethylsiloxane.

Other compounds, either polymer or not, having similar surface-active properties can also be considered.

The invention thus combines two groups of products, by the systematic study of synergistic interactions between them:
the constituents of the matrix;
a synergistic ensemble of solid lubricants.

The method of the invention comprises preparing the surface of the elements to be lubricated.

Makeup-breakout tests showed that to properly establish a transfer film, it is necessary to modify the surface to be coated either by a mechanical treatment such as sand-blasting or shot-blasting, or by physical or chemical modification of the surfaces using a reactive treatment based on crystallized mineral deposits on the surface, chemical attack, for example using an acid, a zinc or manganese phosphatation treatment or oxalation resulting in a surface chemical conversion layer. Among those surface treatments phosphatation is the preferred one as it enables to produce a surface with the proper adhesion resulting in the production of a transfer film resisting during friction and very stable, as well as a base anti-corrosion protection.

It may also be desirable to prepare a complementary surface consisting of impregnating the pores of the surface using nanomaterials the size of which enables them to be inserted into the pores. The aim of said impregnation is to block and saturate sites created by the pores with a material having a passivating action in order to protect the surface against corrosion while keeping good adhesion of the coating.

FIG. 2 diagrammatically shows impregnation of particles 11 into the pore sites 12 of a metallic substrate 13.

The inventors have established that performance was improved in the salt spray test carried out in accordance with the standards cited above (increase of 20% in the corrosion appearance time) by inserting zinc oxide particles which are nanometric in size (mean of 200 nm) applied by simple dispersion in water.

To allow visual identification of the treated surfaces, it is possible to use any known organic colorant in amounts (≦1%, for example) which do not degrade the frictional performances.

To preserve the coating from degradation by oxidation due, for example, to heat or to exposure to UV radiation, it is possible to add one or more antioxidants. Polyphenolic compounds, naphthylamine derivatives and organic phosphites constitute the principal families of antioxidants. The inventors have in particular selected a combination of IRGANOX® L150 (system of polyphenolic and amine antioxidants) and IRGAFOS® 168 (tris(2,4-di-tert-butylphenyl)phosphite) from Ciba-Geigy.

The invention also pertains to modes of application of the coating to allow it to be easily used on an industrial scale. Various techniques can be used to this end, the most suitable thereof being described below.

The hot melt spray technique consists of keeping the product at a high temperature in the liquid phase and spraying it using thermostatted spray guns. The product is heated to between 10° C. and 50° C. above its melting point and sprayed onto a preheated surface at a temperature above the melting point to provide good surface coverage.

In a variation, spraying is carried out on a not-preheated threaded element (i.e. held at ambient temperature). The coating composition is then adapted by addition of a small amount of a surface-active agent, for example 2% maximum, typically 0.6%, of polydimethylsiloxane.

FIG. 3 shows an example of a facility for carrying out the method. The product 20 is melted in a tank 21, stirring using a propeller stirrer 22, then sent via an adjustable pump 24 through a pipe 25 to a spray head 23 which is also supplied with air via a compressor 26. The temperatures of the components 21 and 23 to 26 are adjustable.

A further technique is emulsion coating, in which the product is sprayed in the form of an aqueous emulsion. The emulsion and the substrate may be at ambient temperature, and a drying time is therefore required. Said drying time may be considerably reduced by pre-heating the product to between 60° C. and 80° C. and/or heating the surface to between 50° C. and 150° C.

FIG. 4 illustrates the thermal spray technique or flame spraying technique. In this case, the product 30 in powder form is projected onto the surface to be coated from a gun 31 supplied with air 32 and a fuel gas 33. The powder melts when it passes through the flame 34 and covers its target in a homogeneity manner.

### EXAMPLE

A threaded connection of the VAM TOP HC type with a nominal diameter of 177.8 mm (7 in) and with a weight per unit length of 43.15 kg/m (29 lb/ft) was used formed from low alloy steel (L80 grade) in accordance with the technical specifications issued by the OCTG Division of Vallourec & Mannesmann Tubes.

Before application of the coating, the male threaded element had undergone zinc phosphatation (weight of layer in the range 4 to 20 g/m²) and the female threaded element had undergone manganese phosphatation (weight of layer in the range 8 to 20 g/m²). The threaded elements were preheated to 130° C. and applied thereto was a 35 μm thick layer of a product which was kept molten at 150° C. by hot melt spraying, with the following composition:

| | |
|---|---|
| Polyethylene sold by CLARIANT under the | 19% |
| trade name PE 520 | |
| Carnauba wax | 15% |
| Zinc stearate | 20% |
| PAMA sold by ROHMAX under the trade name | 5% |
| VISCOPLEX 6-950 | |
| Calcium sulphonate derivative sold by LUBRIZOL | 30% |
| under the trade name ALOX 2211 Y | |
| Graphite fluoride | 7% |
| Polytetrafluoroethylene | 2% |
| Boron nitride | 1% |
| Colorant (quinizarine green, C₂₈H₂₂N₂O₂) | 0.5% |

Antioxidants sold by Ciba-Geigy:

| | |
|---|---|
| IRGANOX ® L150 | 0.3% |
| IRGAFOS ® 168 | 0.2% |

Result of salt spray test using ISO 9227 and ISO EN 2846-3: Re=0 after 1000 hours.

The on-site conditions were simulated by a makeup-breakout test in which the coupling 40 (FIG. 5) comprising the female element was held vertically in the fixed jaw 41 of power tongs and the male element, formed at the lower end of a vertically disposed short tube 42 known as a pup joint, was pre-made up by hand into the female element.

To compensate for the shortness of the tube 42 (1 metre) and to simulate a 13 metre long tube, a mass 43 of 420 kg which had been previously suspended from a traveling crane was placed a the upper end of the tube 42, without disposing the centre of gravity of the mass 43 exactly on the axis of the tube 42 and the coupling 40.

The male element was then taken into the moving jaw 44 of the power tongs and made up into the female element with an initial rotation speed of 16 rpm, reducing the speed in the final phase until it stopped when the nominal makeup torque of the uncoated threaded connection was reached, which was 20100 N.m in the example.

Breakout was carried out symmetrically, i.e. at an increasing rotation speed.

More than 10 makeup-breakout cycles could be carried out under these conditions with no degradation of the constituent parts of the threaded elements.

1. A threaded element for a threaded tubular connection which is resistant to galling, comprising
a threading coated with a solid thin coating which is not sticky to the touch and adheres to the substrate, which comprises a solid matrix in which particles of solid lubricants are dispersed,
wherein the solid matrix is lubricating and exhibits plastic or viscoplastic type rheological behaviour, and wherein said particles of solid lubricants comprise particles of lubricants from at least two of classes 1, 2, 3 and 4.

2. A threaded element according to claim 1, in which said matrix has a melting point in the range 80° C. to 320° C.

3. A threaded element according to claim 1, in which said matrix comprises at least one thermoplastic polymer.

4. A threaded element according to claim 3, in which said thermoplastic polymer is polyethylene.

5. A threaded element according to claim 1, in which said matrix comprises at least one metal soap.

6. A threaded element according to claim 5, in which the soap contributes to capture coating debris produced by friction.

7. A threaded element according to claim 5, in which the soap is zinc stearate.

8. A threaded element according to claim 1, in which said matrix comprises at least a wax of vegetable, animal, mineral or synthetic origin.

9. A threaded element according to claim 8, in which the wax contributes to capture debris from the coating produced by friction.

10. A threaded element according to claim 8, in which the wax is carnauba wax.

11. A threaded element according to claim 1, in which said matrix comprises at least one corrosion inhibitor.

12. A threaded element according to claim 11, in which the corrosion inhibitor is a calcium sulphonate derivative.

13. A threaded element according to claim 11, in which the soap is selected to improve the time to appearance of corrosion under the ISO 9227 salt spray corrosion test.

14. A threaded element according to claim 1, in which said matrix comprises at least one liquid polymer with a kinematic viscosity at 100° C. of at least 850 mm²/s.

15. A threaded element according to claim 14, in which said liquid polymer is insoluble in water.

16. A threaded element according to claim 14, in which said liquid polymer is selected from an alkyl polymethacrylate, a polybutene, a polyisobutene and a polydialkylsiloxane.

17. A threaded element according to claim 1, in which the matrix comprises at least one surface-active agent.

18. A threaded element according to claim 1, in which said matrix comprises at least one colorant.

19. A threaded element according to claim 1, in which said matrix comprises at least one antioxidant.

20. A threaded element according to claim 1, in which the solid lubricant particles comprise particles of at least one solid lubricant from class 2 and at least one solid lubricant from class 4.

21. A threaded element according to claim 1, in which the solid lubricant particles comprise particles of at least one solid lubricant from class 1, at least one solid lubricant from class 2 and at least one solid lubricant from class 4.

22. A threaded element according to claim 1, in which the solid lubricant particles do not comprise graphite particles.

23. A threaded element according to claim 1, in which the solid lubricant particles comprise at least boron nitride particles as the solid lubricant from class 1.

24. A threaded element according to claim 1, in which the solid lubricant particles do not comprise molybdenum disulphide particles.

25. A threaded element according to claim 1, in which the solid lubricant particles comprise particles of at least one solid lubricant from class 2 selected from graphite fluoride, sulphides of tin and sulphides of bismuth.

26. A threaded element according to claim 1, in which the solid lubricant particles comprise at least polytetrafluoroethylene particles as the solid lubricant from class 4.

27. A threaded element according to claim 1, in which said coating comprises molecules of at least one fullerene with a spherical geometry.

28. A threaded element according to claim 1, in which the composition by weight of the matrix is as follows:

| | |
|---|---|
| polyethylene homopolymer | 15% to 90% |
| carnauba wax | 5% to 30% |
| zinc stearate | 5% to 30% |
| calcium sulphonate derivative | 0 to 50% |
| alkyl polymethacrylate | 0 to 15% |
| colorant | 0 to 1% |
| antioxidant | 0 to 1% |

29. A threaded element according to claim 1, in which the composition by weight of the matrix is as follows:

| | |
|---|---|
| polyethylene homopolymer | 15% to 90% |
| carnauba wax | 5% to 30% |
| zinc stearate | 5% to 30% |
| calcium sulphonate derivative | 0 to 50% |
| alkyl polymethacrylate | 0 to 15% |
| polydimethylsiloxane | 0 to 2% |
| colorant | 0 to 1% |
| antioxidant | 0 to 1% |

30. A threaded element according to claim 1, in which the composition by weight of the solid lubricants is as follows:

| | |
|---|---|
| graphite fluoride | 20% to 99% |
| boron nitride | 0% to 30% |
| polytetrafluoroethylene | 1% to 80% |

31. A threaded element according to claim 1, in which the solution by weight of the solid lubricants is as follows:

| | |
|---|---|
| sulphides of tin | 20% to 99% |
| boron nitride | 0 to 30% |
| polytetrafluoroethylene | 1% to 80% |

32. A threaded element according to claim 1, in which the composition by weight of the solid lubricants is as follows:

| | |
|---|---|
| sulphides of bismuth | 20% to 99% |
| boron nitride | 0 to 30% |
| polytetrafluoroethylene | 1% to 80% |

33. A threaded element according to claim 1, in which the composition by weight of the coating is as follows:

| | |
|---|---|
| matrix | 70% to 95% |
| solid lubricants | 5% to 30% |

34. A threaded element according to claim 1, in which the thickness of the coating is in the range 10 μm to 50 μm.

35. A threaded element according to claim 1, in which the coating is also applied to a sealing surface which is fitted to come into sealing contact with a corresponding surface of a second threaded element after assembling the two threaded elements by makeup.

36. A threaded tubular connection comprising a male threaded element and a female threaded element, wherein at least one of said threaded elements is in accordance with claim 1.

37. A method for finishing a threaded tubular element, in which a thin layer of a solid anti-galling coating is applied to at least the surface of the threading to obtain a solid coating, wherein the surface to be coated undergoes a surface treatment for improving adhesion of the coating and in that the constituents of said coating are as defined in claim 1.

38. A method according to claim 37, in which the constituents of the coating are heated to a temperature which is higher than the melting point of the matrix and the coating is then applied by spraying said constituents comprising the molten matrix.

39. A method according to claim 37, in which the coating is applied by projection through a flame of a powder formed by the constituents of the coating.

40. A method according to claim 37, in which the coating is applied by spraying an aqueous emulsion in which the constituents of the coating are dispersed.

41. A method according to claim 37, in which the threaded element is heated to a temperature of 80° C. or more.

42. A method according to claim 37 in which the threaded element is held at ambient temperature.

43. A method according to claim 37, in which said surface treatment is selected from mechanical treatments, chemical treatments and non reactive deposits.

44. A method according to claim 37, in which the surface to be coated is a metallic surface and said surface treatment is a treatment for chemical conversion of said surface.

45. A method according to claim 44, in which said chemical conversion treatment is a phosphatation.

46. A method according to claim 37, in which said surface treatment is followed by a treatment for impregnating the roughness or pores of the surface to be coated by nanomaterials with an anticorrosive action.

47. A method according to claim 46, in which said nanomaterials are particles of zinc oxide.

48. A method according to claim 46, in which said nanomaterials have a mean particle size of the order of 200 nm.

49. A method according to claim 46, in which said nanomaterials are applied in the form of an aqueous dispersion.
